(19) United States
(12) Patent Application Publication
(10) Pub. No.: US 2018/0282616 A1
(43) Pub. Date: Oct. 4, 2018

(54) AQUEOUS DOWNHOLE FLUIDS HAVING POLYMERS AND CHARGED NANOPARTICLES

(71) Applicant: Baker Hughes, a GE company, LLC, Houston, TX (US)

(72) Inventors: Saet B. Debord, Katy, TX (US); Chistabel Tomla, Katy, TX (US)

(73) Assignee: Baker Hughes, a GE company, LLC, Houston, TX (US)

(21) Appl. No.: 16/002,790

(22) Filed: Jun. 7, 2018

Related U.S. Application Data
(63) Continuation-in-part of application No. 14/464,395, filed on Aug. 20, 2014, now abandoned.
(60) Provisional application No. 61/868,816, filed on Aug. 22, 2013.

(51) Int. Cl. C09K 8/88; C09K 8/68; C09K 8/60; E21B 43/16

(52) U.S. Cl. CPC C09K 8/887; C09K 8/885; C09K 2208/10; C09K 8/602; E21B 43/16; C09K 8/685

(57) ABSTRACT

Polymers comprising polyacrylic acid or polyacrylamide grafted onto a polyethylene oxide/polypropylene oxide copolymer and/or charged nanoparticles may be added to an aqueous downhole fluid having polymers therein to viscosify the aqueous downhole fluid using an amount of such grafted polymers that is less than the amount of polymers that would be needed to viscosify an identical aqueous downhole fluid absent such grafted polymers. The grafted polymers may confer a reversible viscosity property to the fluid when the grafted polymers are dissolved in water or brine in a certain pH range.

### CROSS-REFERENCE TO RELATED APPLICATION

This application is a Continuation-in-Part of U.S. application Ser. No. 14/464,395 filed Aug. 20, 2014, which claims the benefit of Provisional Patent Application No. 61/868,816 filed Aug. 22, 2013, both of which are incorporated by reference herein in their entirety.

### TECHNICAL FIELD

The present invention relates to fluid compositions and methods of using aqueous downhole fluids, such as fracturing fluids or injection fluids, having polymers and optionally charged nanoparticles therein, and more specifically relates to the viscosifying of an aqueous downhole fluid by the addition of a reduced amount of polymers and/or the charged nanoparticles than would otherwise be necessary.

### BACKGROUND

In the exploration of oil and gas, viscosified fluids are used in various aqueous injection fluids for injection operations and fracturing fluids for fracturing operations.

The development of suitable fracturing fluids is a complex art for use with hydraulic fracturing to improve the recovery of hydrocarbons from the formation. Once hydraulic fracturing begins, and the crack or cracks are made, high permeability proppant, relative to the formation permeability, is pumped into the fracture to prop open the crack. When the applied pump rates and pressures are reduced or removed from the formation, the crack or fracture cannot close or heal completely because the high permeability proppant keeps the crack open. The propped crack or fracture provides a high permeability path connecting the producing wellbore to a larger formation area to enhance the production of hydrocarbons.

The fracturing fluids must simultaneously meet a number of conditions. For example, they must be stable at high temperatures and/or high pump rates and shear rates that can cause the fluids to degrade and prematurely settle out the proppant before the fracturing operation is complete. Various fluids have been developed, but most commercially used fracturing fluids are aqueous based liquids that have either been gelled or foamed. When the fluids are gelled, typically a polymeric gelling agent, such as a solvatable polysaccharide, e.g. guar and derivatized guar polysaccharides, is used. The thickened or gelled fluid helps keep the proppants within the fluid. Gelling can be accomplished or improved by the use of crosslinking agents or cross-linkers that promote crosslinking of the polymers together, thereby increasing the viscosity of the fluid. One of the more common cross-linked polymeric fluids is borate cross-linked guar.

Injection operations are considered a secondary method of hydrocarbon recovery and may be necessary when the primary recovery operation has left behind a substantial quantity of hydrocarbons in the subterranean formation. For example, in injection operations the energy for producing the remaining hydrocarbons from the subterranean formation may be supplied by the injection of fluids into the formation under pressure through one or more injection wells penetrating the formation, whereby the injection fluids drive the hydrocarbons to one or more producing wells penetrating the formation.

Suitable injection fluids include, among other things, water, steam, carbon dioxide, and natural gas. However, the sweep efficiency of injection operations may vary greatly depending on a number of factors, such as variability in the permeability of the formation. In particular, where the subterranean formation contains high permeability zones, the injection fluids may flow through the areas of least resistance, e.g., through the high permeability zones, thereby bypassing less permeable zones. While injection operations may provide the energy necessary to produce hydrocarbons from the high permeability zones, hydrocarbons contained within less permeable zones may not be driven to the one or more production wells penetrating the formation.

A variety of techniques have been attempted to improve the efficiency of injection operations. One such technique, known as “polymer flooding” comprises the addition of water-soluble polymers, such as polyacrylamide, to the injection fluid in order to increase the viscosity of the injection fluid to allow a better sweep efficiency by the injection fluid of the displacement of hydrocarbons through the formation. The viscosified injection fluid may be less likely to by-pass the hydrocarbons and push the remaining hydrocarbons out of the formation.

It would be desirable if an aqueous downhole fluid could obtain a pre-determined viscosity by using a reduced amount of polymers for viscosifying the fluid.

### SUMMARY

There is provided in one form, a fluid composition comprising an aqueous downhole fluid and at least one polymer comprising either polyacrylic acid or polyacrylamide grafted onto a polyethylene oxide/polypropylene oxide copolymer, the at least one polymer being present in an amount that is less than the amount that would be necessary to obtain a pre-determined viscosity of the aqueous downhole fluid in an otherwise identical aqueous downhole fluid absent the at least one polymer. The at least one polymer, in another embodiment, may be dissolved in water or brine and have a pH ranging from about 3 to about 4.5 in order to increase the viscosity of the aqueous downhole fluid with an increase in temperature or decrease the viscosity of the fluid with a decrease in temperature.

In a separate form, the fluid composition may also contain charged nanoparticles and surfactants, the surfactants optionally being combined with the at least one polymer to form a microemulsion.

There is also provided a method for increasing the viscosity of an aqueous downhole fluid comprising the steps of circulating an aqueous downhole fluid into a subterranean reservoir, wherein the aqueous downhole fluid comprises at least one polymer that is polyacrylic acid or polyacrylamide grafted onto a polyethylene oxide/polypropylene oxide copolymer; and increasing the viscosity of the aqueous downhole fluid using an amount of the at least one polymer that is less than an amount of polymer that would be needed to viscosify an identical aqueous downhole fluid absent the at least one polymer.

### DETAILED DESCRIPTION

It has been discovered that an effective amount of charged nanoparticles within an aqueous downhole fluid may crosslink at least a portion of the polymers within the aqueous downhole fluid. Although the inventors do not wish to be limited to a particular theory, it is believed that the crosslinking may occur by coulombic attraction, e.g. ionic bonding, or depletion flocculation (destabilisation of colloidal dispersions by free, non-adsorbing polymer molecules in solution), which also allows the cross-linking to be reversible. The cross-linking may be thermally reversible. The viscosity may increase with an increase in temperature, and then the viscosity may decrease with a decrease in temperature. Likewise, cross-linking is reversible, and the cross-linking may increase with an increase in temperature, and then the cross-linking may decrease with a decrease in temperature. The viscosity ‘peaks’ as the temperature steadily increases and then returns to normal as the temperature decreases. The viscosity may be increased and decreased many times depending on the temperature. This type of polymer may be referred to as a ‘smart’ polymer in a non-limiting embodiment because the viscosity may vary depending on the temperature, as previously mentioned.

Moreover, the use of the charged nanoparticles may reduce the amount of polymers required to obtain a pre-determined viscosity of the aqueous downhole fluid as compared to an identical aqueous downhole fluid absent the charged nanoparticles. ‘Charged nanoparticles’ are defined herein to be nanoparticles having a coulombic attraction to the polymers within the downhole aqueous fluid where the charge may be increased or decreased as needed depending on the type and/or use of the polymers.

Complete cross-linking of the polymers by the charged nanoparticles is desirable, but it should be appreciated that complete cross-linking is not necessary for the methods and compositions herein to be considered effective. Success is obtained if more polymers are cross-linked using the charged nanoparticles than in the absence of the charged nanoparticles. Alternatively, the method described is considered successful if a majority of the polymers are cross-linked by the charged nanoparticles, or from about 70 wt % independently to about 99 wt % of the polymers in another non-limiting embodiment.

The charged nanoparticles may be present in the aqueous downhole fluid in an effective amount to crosslink at least a portion of the polymers therein. Alternatively, the amount of the charged nanoparticles within the aqueous downhole fluid may range from about 0.1 ppm to about 5000 ppm, from about 0.1 ppm independently to about 1000 ppm, or from about 1 ppm independently to about 300 ppm in another non-limiting embodiment. As used herein with respect to a range, “independently” means that any lower threshold may be used together with any upper threshold to give a suitable alternative range.

The charged nanoparticles may be or include, but are not limited to clay nanoparticles, modified nanoparticles, and combinations thereof. The clay nanoparticles may be or include, but are not limited to, laponite, bentonite, and combinations thereof. Laponite nanoparticles are highly charged synthetic clay nanoparticles, and the chemistry is similar to micron-sized bentonite. However, the larger size of the bentonite makes it difficult to use for cross-linking the polymers within the aqueous downhole fluids as compared to the clay nanoparticles described herein.

The modified nanoparticles may be or include, but are not limited to modified graphene nanoparticles, modified graphene platelets, modified graphene oxide, modified nanorods, modified nanoplatelets, and combinations thereof. The modified nanoparticles may be chemically-modified, covalently-modified, exfoliated, physically-modified, electrostatically modified, and combinations thereof. The modification to the nanoparticles may improve the coulombic attraction of the nanoparticles as compared to otherwise identical nanoparticles that have not been modified.

The charged nanoparticles may have at least one dimension no greater than about 1000 nm. Alternatively, the average particle size of the charged nanoparticle is less than or equal to about 999 nm, or alternatively the average particle size may range from about 1 nm independently to about 500 nm. In another non-limiting embodiment, the charged nanoparticles may have a disk shape where the width of the disk ranges from about 0.5 nm independently to about 5 nm, alternatively from about 1 nm independently to about 3 nm. The diameter of the disk may range from about 15 nm independently to about 35 nm, or from about 20 nm independently to about 30 nm in another non-limiting embodiment.

Graphene is an allotrope of carbon, whose structure is a planar sheet of sp²-bonded carbon atoms that are densely packed in a 2-dimensional honeycomb crystal lattice. The term “graphene” is used herein to include particles that may contain more than one atomic plane, but still with a layered morphology, i.e. one in which one of the dimensions is significantly smaller than the other two, and also may include any graphene that has been chemically modified, physically modified, covalently modified, and/or functionally modified. Although there is no exact maximum number of layers in graphene, a typical maximum number of monoatomic-thick layers in the graphene nanoparticles here is between fifty (50) and one hundred (100). The graphene may have at least one graphene sheet, and each graphene platelet may have a thickness no greater than 100 nm.

The structure of graphene is hexagonal, and graphene is often referred to as a 2-dimensional (2-D) material. The 2-D morphology of the graphene nanoparticles is of utmost importance when carrying out the useful applications relevant to the graphene nanoparticles. The applications of graphite, the 3-D version of graphene, are not equivalent to the 2-D applications of graphene.

Graphene is in the form of one-atomic layer thick or multi-atomic layer thick platelets. Graphene platelets may have in-plane dimensions ranging from sub-micrometer to about 100 s micrometers. These types of platelets share many of the same characteristics as carbon nanotubes. The platelet chemical structure makes it easier to functionalize or modify the platelet for enhanced dispersion of the modified nanoparticles within the aqueous downhole fluid. The graphene platelets are also fifty (50) times stronger than steel with a surface area that is twice that of carbon nanotubes.

Carbon nanotubes are defined herein as allotropes of carbon consisting of one or several single-atomic layers of graphene rolled into a cylindrical nanostructure. Nanotubes may be single-walled, double-walled or multi-walled.

While materials on a micron scale have properties similar to the larger materials from which they are derived, assuming homogeneous composition, the same is not true of nanoparticles. An immediate example is the very large interfacial or surface area per volume for nanoparticles. The consequence of this phenomenon is a very large potential for interaction with other matter, as a function of volume. For nanoparticles, the surface area may be up to 1800 m²/g. Additionally, because of the very large surface area to volume present with charged nanoparticles, it is expected that in most, if not all cases, much less proportion of charged nanoparticles need be employed relative to micron-sized additives conventionally used to achieve or accomplish a similar effect.

Nevertheless, it should be understood that surface-modified nanoparticles may find utility in the compositions and methods herein. “Surface-modification” is defined here as the process of altering or modifying the surface properties of a particle by any means, including but not limited to physical, chemical, electrochemical or mechanical means, and with the intent to provide a unique desirable property or combination of properties to the surface of the nanoparticle, which differs from the properties of the surface of the unprocessed nanoparticle.

The nanoparticles may be functionally modified to introduce chemical functional groups thereon, for instance by reacting the graphene nanoparticles with a peroxide such as diacyl peroxide to add acyl groups which are in turn reacted with diamines to give amine functionality, which may be further reacted. Functionalized nanoparticles are defined herein as those which have had their edges or surfaces modified to contain at least one functional group including, but not necessarily limited to, sulfonate, sulfate, sulfosuccinate, thiosulfate, succinate, carboxylate, hydroxyl, glucoside, ethoxylate, propoxylate, phosphate, ethoxylate, ether, amines, amides, ethoxylate-propoxylate, an alkyl, an alkenyl, a phenyl, a benzyl, a perfluoro, thiol, an ester, an epoxy, a keto, a lactone, a metal, an organo-metallic group, an oligomer, a polymer, or combinations thereof.

Exemplary methods of functionalizing may include, but are not limited to, reactions such as oxidation or oxidative cleavage of polymers to form alcohols, diols, or carbonyl groups including aldehydes, ketones, or carboxylic acids; diazotization of polymers proceeding by the Sandmeyer reaction; intercalation/metallization of a nanodiamond by treatment with a reactive metal such as an alkali metal including lithium, sodium, potassium, and the like, to form an anionic intermediate, followed by treatment with a molecule capable of reacting with the metalized nanodiamond such as a carbonyl-containing species (carbon dioxide, carboxylic acids, anhydrides, esters, amides, imides, etc.), an alkyl species having a leaving group such as a halide (Cl, Br, I), a tosylate, a mesylate, or other reactive esters such as alkyl halides, alkyl tosylates, etc.; molecules having benzylic functional groups; use of transmetalated species with boron, zinc, or tin groups which react with e.g., aromatic halides in the presence of catalysts such as palladium, copper, or nickel, which proceed via mechanisms such as that of a Suzuki coupling reaction or the Stille reaction, and combinations thereof.

It will be appreciated that the above methods are intended to illustrate the concept of introducing functional groups to a nanoparticle, and should not be considered as limiting to such methods.

Prior to functionalization the nanoparticle may be exfoliated. Exemplary exfoliation methods include, but are not necessarily limited to, those practiced in the art such as fluorination, acid intercalation, acid intercalation followed by thermal shock treatment, and the like. Exfoliation of the nanographene provides a nanographene having fewer layers than non-exfoliated nanographene.

Covalent functionalization may include, but is not necessarily limited to, oxidation and subsequent chemical modification of oxidized nanoparticles, fluorination, free radical additions, addition of carbenes, nitrenes and other radicals, arylamine attachment via diazonium chemistry, and the like. Besides covalent functionalization, chemical functionality may be introduced by noncovalent functionalization, electrostatic interactions, π-π interactions and polymer interactions, such as wrapping a nanoparticle with a polymer, direct attachment of reactants to nanoparticles by attacking the sp² bonds, direct attachment to ends of nanoparticles or to the edges of the nanoparticles, and the like.

Related to fracturing fluids, the amount of polymers within the aqueous downhole fluid for subsequent formation of a gelled aqueous fluid depends on at least two factors. One involves generating enough viscosity to control the rate of fluid leak off into the pores of the fracture, and the second involves creating a viscosity high enough to keep the proppant particles suspended therein during the fluid injecting step, in the non-limiting case of a fracturing fluid. Thus, depending on the application, the polymers are added to the aqueous fracturing fluid in concentrations ranging from about 0.5% independently to about 25% by volume, alternatively up to about 12 vol % of the total gelled aqueous fluid (from about 5 gptg independently to about 120 gptg). In another non-limiting embodiment, the range for polymers within the gelled aqueous fluid may be from about 1.0% independently to about 10.0% by volume polymers. In an alternate embodiment, the amount of polymers ranges from about 2% independently to about 6% by volume. One skilled in the art would understand what specific amount of charged nanoparticles that may be needed depending on the type of aqueous downhole fluid and use of the fluid, type of formation, etc.

The aqueous downhole fluid may include water, salt water, brine, produced water, or seawater. The salt water may be water containing one or more salts dissolved therein. Other types of aqueous downhole fluids may include oil-in-water emulsions, oil-in-brine emulsions, and combinations thereof. The temperature of the aqueous downhole fluid may range from about 60° F. (about 15° C.) independently to about 300° F. (about 150° C.) and still maintain the viscosity of the aqueous downhole fluid, alternatively from about 75° F. (about 23° C.) independently to about 175° F. (about 80° C.).

In one non-limiting embodiment of the invention, it is desirable that the cross-linking of the polymers within the aqueous downhole fluid be uniform, which requires the distribution of the charged nanoparticles to be uniform. If the charged nanoparticles flocculate, drop out, or precipitate, the crosslinking of the polymers within the aqueous downhole fluid may change.

Any suitable mixing apparatus may be used to incorporate the charged nanoparticles into an aqueous downhole fluid. In the case of batch mixing, the polymers and the aqueous downhole fluid are blended for a period of time sufficient to form a gelled or viscosified solution. The gelled aqueous downhole fluid may be prepared by blending the polymers into the aqueous downhole fluid before, during, or after the charged nanoparticles have been added.

In some cases, the nanoparticles may change the properties of the aqueous downhole fluids in which they reside, based on various stimuli including, but not necessarily limited to, temperature, pressure, rheology, pH, chemical composition, salinity, and the like. This is due to the fact that the charged nanoparticles can be custom designed on an atomic level to have very specific functional groups, and thus the charged nanoparticles react to a change in surroundings or conditions in a way that is beneficial. It should be understood that it is expected that the charged nanoparticles may have more than one type of functional group, making them multifunctional. Multifunctional nanoparticles may be useful for simultaneous applications, such as but not limited to, increasing the temperature stability of the aqueous downhole fluid, while also cross-linking at least a portion of the polymers therein.

In an alternative non-limiting embodiment, the aqueous downhole fluid may or may not include charged nanoparticles. For example, an aqueous downhole fluid composition may include an aqueous downhole fluid and at least one grafted polymer where the grafted polymer(s) are present in the aqueous downhole fluid in in an amount to obtain a pre-determined viscosity or to increase the viscosity of the aqueous downhole fluid that is less than an amount of polymer that would be needed to viscosify or obtain a pre-determined viscosity of an identical aqueous downhole fluid absent the grafted polymer(s). The grafted polymer(s) may have at least one functional group, such as but not limited to, polyacrylamide, polyvinyl, polyacrylic acid, and combinations thereof. ‘Grafted polymer’ is defined herein to be a polymer, such as that described herein, having a functional group grafted thereonto.

Suitable grafted polymers include, without limitation, a polyacrylic acid grafted onto a polyethylene oxide/polypropylene oxide copolymer or polyacrylamide grafted onto a polyethylene oxide/polypropylene oxide copolymer.

It has also been discovered that a grafted polymer, such as a polyacrylic acid or polyacrylamide grafted onto a polyethylene oxide/polypropylene oxide copolymer, when dissolved in water or brine and having a pH ranging from about 3 to about 4.5, confers a reversible viscosity property to the downhole fluid in which the viscosity of the aqueous downhole fluid decreases with a decrease in temperature of the aqueous downhole fluid and increases with an increase in temperature of the downhole fluid. This property may be conferred to the downhole fluid in the absence of charged nanoparticles.

Moreover, it has been discovered that a downhole fluid comprising such a grafted polymer may experience an increase in viscosity at 150° F. when changing pH of the grafted polymer from about 4.5 to about 7.5. At 200° F., such a grafted polymer has been shown to increase viscosity of the downhole fluid it is in by 40% when the pH of the grafted polymer is changed from about 4.5 to about 7.5 and by 52% when the pH of the grafted polymer is changed from about 4.5 to about 11.

In another non-limiting embodiment, the functional group (e.g. polyvinyl in a non-limiting embodiment) grafted onto the polymers may increase the oil solubility of the charged nanoparticles and/or the polymers. Alternatively, the functional group grafted onto the polymer(s) may decrease the amount of polymer needed and/or the amount of charged nanoparticles needed as compared to the aqueous downhole fluid absent the functional group(s) grafted onto the polymer(s). Also, the functional group(s) grafted onto the polymer(s) may enhance the polymer's solubility in salt solutions.

The effective amount of the polymers, grafted or otherwise, within the aqueous downhole fluid may range from about 10 ppm independently to about 10000 ppm, alternatively from about 5 ppm independently to about 5000 ppm. The viscosity of the aqueous downhole fluid may be up to about 600 cP depending on the use of the aqueous downhole fluid. In one non-limiting embodiment, the viscosity may range from about 10 independently to about 30 cP. The polymers may be or include, but are not limited to polyacrylamide, xanthan, guar, polyacrylic acid, poly 2-acrylamido-2-methyl-1-propane sulfonic acid (AMPS), polyethylene oxide, polypropylene oxide, and combinations thereof; and the polymers may be homopolymers, copolymers, terpolymers, and combinations thereof. One non-limiting example of the polymers may be or include the PLURONICS™ from BASF (The Chemical Company), which is ethylene oxide, propylene oxide, ethylene oxide as a tri block copolymer.

The use of surfactants together with the nanoparticles may form self-assembly structures that may enhance the thermodynamic, physical, and rheological properties of these types of fluids. The use of surfactants is optional. It may be helpful in designing new fluids containing engineered nanoparticles to match the amount of the nanoparticles with the proper surfactant/aqueous downhole fluid ratio to achieve the desired dispersion for the particular aqueous downhole fluid. Such surfactants may be present in the aqueous downhole fluid fluids in amounts from about 0.01 wt % independently to about 15 wt %, alternatively from about 0.01 wt % independently to about 5 wt %.

Ways of dispersing colloidal-size particles in fluids is known, but how to disperse nanoparticles within the aqueous downhole fluids may be a challenge. Expected suitable surfactants may include, but are not necessarily limited to non-ionic, anionic, cationic, amphoteric surfactants and zwitterionic surfactants, janus surfactants, and blends thereof. Suitable nonionic surfactants may include, but are not necessarily limited to, alkyl polyglycosides, sorbitan esters, methyl glucoside esters, amine ethoxylates, diamine ethoxylates, polyglycerol esters, alkyl ethoxylates, alcohols that have been polypropoxylated and/or polyethoxylated or both. Suitable anionic surfactants may include alkali metal alkyl sulfates, alkyl ether sulfonates, alkyl sulfonates, alkyl aryl sulfonates, linear and branched alkyl ether sulfates and sulfonates, alcohol polypropoxylated sulfates, alcohol polyethoxylated sulfates, alcohol polypropoxylated polyethoxylated sulfates, alkyl disulfonates, alkylaryl disulfonates, alkyl disulfates, alkyl sulfosuccinates, alkyl ether sulfates, linear and branched ether sulfates, alkali metal carboxylates, fatty acid carboxylates, and phosphate esters. Suitable cationic surfactants may include, but are not necessarily limited to, arginine methyl esters, alkanolamines and alkylenediamides. Suitable surfactants may also include surfactants containing a non-ionic spacer-arm central extension and an ionic or nonionic polar group. Other suitable surfactants may be dimeric or gemini surfactants, cleavable surfactants, janus surfactants, and extended surfactants also called extended chain surfactants.

In a separate non-limiting embodiment, these surfactants may also be combined with at least one grafted polymer of the kind discussed above to form a microemulsion, allowing the use of a lesser amount of surfactants than would otherwise be necessary to flood hydrocarbons out of a subterranean reservoir using an aqueous downhole absent such a microemulsion.

Sufficient volumes of the aqueous downhole fluid may be injected into the subterranean formation for fracturing the formation and/or for an injection operation. The volume of the aqueous downhole fluids to inject into the formation will be based, inter alia, on several properties of the zone to be treated, such as depth and volume of the zone, as well as the permeability and other physical properties of the material in the zone. One of ordinary skill in the art would understand what the proper volume of the aqueous downhole fluid would be needed depending on the type of fluid used for a specific application, e.g. fracturing or injection operation.

In the foregoing specification, the invention has been described with reference to specific embodiments thereof, and has been described as effective in providing methods and compositions for reducing the amount of polymers within an aqueous downhole fluid. However, it will be evident that various modifications and changes can be made thereto without departing from the broader spirit or scope of the invention as set forth in the appended claims. Accordingly, the specification is to be regarded in an illustrative rather than a restrictive sense. For example, specific aqueous downhole fluids, charged nanoparticles, polymers, and modifications falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the fluids and methods may consist of or consist essentially of fluids and methods for reducing the amount of polymers within an aqueous downhole fluid by adding charged nanoparticles in an effective amount to the aqueous downhole fluid comprising polymers, such as but not limited to polyacrylamide, xanthan, guar, polyacrylic acid, poly 2-acrylamido-2-methyl-1-propane sulfonic acid (AMPS), polyethylene oxide, polypropylene oxide, and combinations thereof where the charged nanoparticles may be or include clay nanoparticles, modified nanoparticles, and combinations thereof and where at least a portion of the polymers are cross-linked by the charged nanoparticles, and the aqueous downhole fluid may be a fracturing fluid, an injection fluid, and combinations thereof. An effective amount of charged nanoparticles may reduce the amount of polymers necessary to obtain a pre-determined viscosity of the aqueous downhole fluid as compared to the amount of polymers necessary to obtain the same pre-determined viscosity of an otherwise identical aqueous downhole fluid absent the charged nanoparticles.

The words “comprising” and “comprises” as used throughout the claims, are to be interpreted to mean “including but not limited to” and “includes but not limited to”, respectively.

What is claimed is:

1. A fluid composition comprising:
an aqueous downhole fluid;
at least one polymer in the aqueous downhole fluid, the at least one polymer comprising either polyacrylic acid or polyacrylamide grafted onto a polyethylene oxide/polypropylene oxide copolymer;
wherein the at least one polymer is present in the aqueous downhole fluid in an amount less than an amount that would be necessary to obtain a pre-determined viscosity of the aqueous downhole fluid in an otherwise identical aqueous downhole fluid absent the at least one polymer.

2. The fluid composition of claim 1, wherein the at least one polymer is dissolved in water or brine.

3. The fluid composition of claim 2, wherein the solution of the at least one polymer and the water or brine has a pH ranging from about 3 to about 4.5.

4. The fluid composition of claim 3, wherein the viscosity of the aqueous downhole fluid decreases with a decrease in temperature of the aqueous downhole fluid and the viscosity of the aqueous downhole fluid increases with an increase in temperature of the downhole fluid.

5. The fluid composition of claim 1, wherein the fluid composition further comprises charged nanoparticles in an amount effective to crosslink at least a portion of the at least one polymer, where the charged nanoparticles are selected from the group consisting of clay nanoparticles, modified nanoparticles, and combinations thereof.

6. The fluid composition of claim 5, wherein the clay nanoparticles are selected from the group consisting of laponite, bentonite, and combinations thereof.

7. The fluid composition of claim 1, wherein the charged nanoparticles have an average particle size equal to or less than 999 nm.

8. The fluid composition of claim 5, wherein the amount of the charged nanoparticles within the aqueous downhole fluid ranges from about 0.1 ppm to about 5000 ppm.

9. The fluid composition of claim 1, wherein the amount of the at least one polymer within the aqueous downhole fluid ranges from about 10 ppm to about 10000 ppm.

10. The fluid composition of claim 1, wherein the fluid composition has an increased viscosity when the temperature ranges from about 60° F. (about 15° C.) to about 300° F. (about 150° C.) as compared to the viscosity of the fluid composition when the temperature is less than about 60° F. (about 15° C.).

11. The fluid composition of claim 1, wherein the fluid composition further comprises at least one surfactant.

12. The fluid composition of claim 11, wherein the at least one surfactant may be combined with the at least one polymer to form a microemulsion.

13. The fluid composition of claim 11, wherein the at least one surfactant is selected from the group consisting of a non-ionic surfactant, an anionic surfactant, a cationic surfactant, an amphoteric surfactant, a zwitterionic surfactant, a janus surfactant, and blends thereof.

14. The fluid composition of claim 12, wherein the at least one surfactant is present in the aqueous downhole fluid in an amount less than an amount that would otherwise be necessary to flood hydrocarbons out of a subterranean reservoir using the aqueous downhole absent the microemulsion.

15. The fluid composition of claim 1, wherein the aqueous downhole fluid is either a fracturing fluid or an injection fluid.

16. A method for increasing the viscosity of an aqueous downhole fluid comprising:
circulating an aqueous downhole fluid into a subterranean reservoir, wherein the aqueous downhole fluid comprises at least one polymer that is polyacrylic acid or polyacrylamide grafted onto a polyethylene oxide/polypropylene oxide copolymer; and
increasing the viscosity of the aqueous downhole fluid using an amount of the at least one polymer that is less than an amount of polymer that would be needed to viscosify an identical aqueous downhole fluid absent the at least one polymer.

17. The method of claim 11, wherein the at least one polymer is dissolved in water or brine.

18. The method of claim 17, wherein the viscosity of the at least one polymer may be increased by increasing the pH of the solution of the at least one polymer and the water or brine to a pH of about 11.
